(19) United States
(12) Patent Application Publication
(10) Pub. No.: US 2014/0020096 A1
(43) Pub. Date: Jan. 16, 2014

(54) SYSTEM TO PROFILE APPLICATION SOFTWARE

(71) Applicant: Clutch Mobile, Inc., San Mateo, CA (US)

(72) Inventors: Muhammad Khan, San Mateo, CA (US); Sydney Pang, San Mateo, CA (US); Garrett Larsson, San Mateo, CA (US); Brandon Salzberg, San Mateo, CA (US); Jesse Berman, San Mateo, CA (US)

(21) Appl. No.: 13/939,030

(22) Filed: Jul. 10, 2013

Related U.S. Application Data
(60) Provisional application No. 61/670,343, filed on Jul. 11, 2012.

(51) Int. Cl. G06F 21/52

(52) U.S. Cl. CPC G06F 21/52
USPC 726/22

(57) ABSTRACT

In an example, a system is provided, the system including mobile device having an instance of a operating system installed thereon and a remote device coupled to the mobile device via a network, the remote device having an instrumented instance of the same operating system installed thereon. The remote device may be configured to install an instance of a new application on the remote device responsive to receiving a signal that originates from the mobile device and is indicative of the new application on the mobile device. The remote device may be configured to run the installed instance and determine whether the remote device performed any operations included in a preset list of operations.

### PRIORITY

This application claims benefit of U.S. Provisional Application No. 61/670,343 filed on Jul. 11, 2012, entitled: SYSTEM TO PROFILE APPS & DETECT MALWARE ON ANDROID, which is herein incorporated by reference in its entirety.

### COPYRIGHT NOTICE

©2013 Clutch Mobile, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND OF THE INVENTION

Mobile devices such as smartphones, tablets, Personal Digital Assistants (PDAs), or other ultra-portable personal portable devices, pose different security issues than traditional computers because the mobile devices may be always connected, more frequently used, and/or used as a personal device.

### BRIEF DESCRIPTION OF THE DRAWINGS

FIG. 1 illustrates a system to profile application software.

FIG. 2 illustrates a flow chart showing an application profiling operation of the processing device 16 of FIG. 1.

FIG. 3 illustrates a flow chart showing an entry point discovery operation of the processing device 16 of FIG. 1.

FIG. 4 illustrates a flow chart showing an event chaining operation of the processing device 16 of FIG. 1.

FIG. 5 illustrates a flow chart showing an application tracking operation of the processing device 16 of FIG. 1.

### DETAILED DESCRIPTION OF PREFERRED EMBODIMENTS

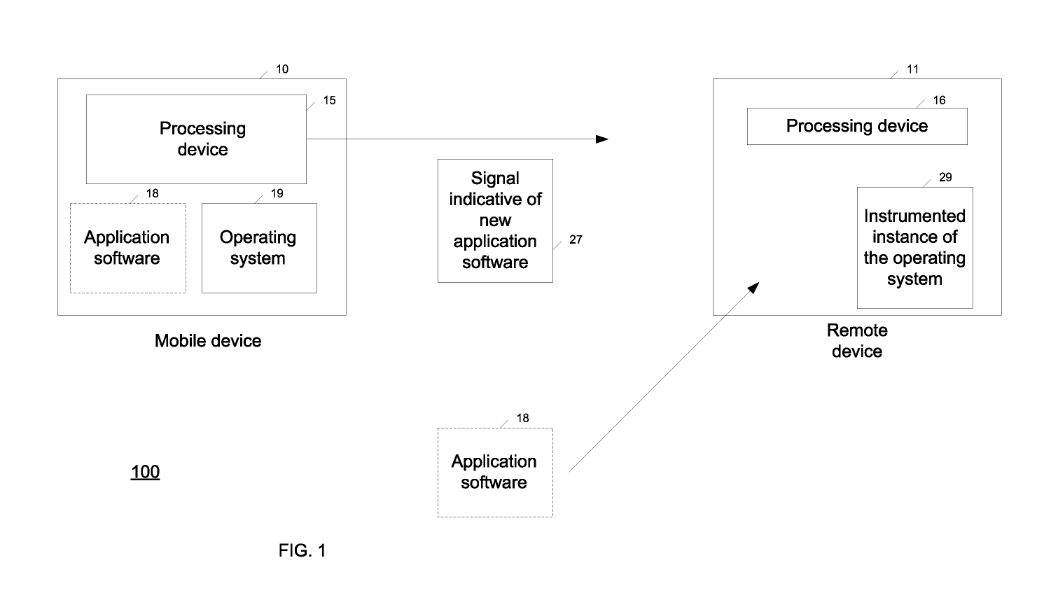

FIG. 1 illustrates a system to profile application software.

System 100 includes a mobile device 10, e.g., a smartphone, a tablet, PDA, or the like, and a remote device 11, e.g., one or more servers. The mobile device 10 includes a processing device 15 and an operating system 19, e.g., a mobile operating system (Android™, iOS™, or the like). The remote device 11 includes a processing device 16 and an instrumented instance 29 of the operating system 19.

The processing device 15 may be configured to transmit a signal 27 to the remote device 11 indicative of a new application software 18 on the mobile device 10. In an example, the processing device 15 may be configured to constantly scan for new applications, and responsive to detecting a new application, transmit information about the detected application to the remote device 11.

The remote device 11 includes a processing device 16 that may be configured to, responsive to receiving the signal 27, install an instance, e.g., an instrumented instance, of the application software 18 on the remote device 11. In an example, the processing device 16 presents a smartphone platform, a tablet platform, or a PDA platform to the application software 18 (or a modified version thereof) to cause the application software 18 (or the modified version thereof) to respond during installation as if the remote device 11 (which again may be one or more servers) were a physical smartphone device, a physical tablet device, or a physical PDA device.

The processing device 16 may be configured to run the installed instance. As the application runs, the processing device 16 will monitor the application software 18 and the remote device 11 to see what the application software 18 is actually doing. The processing device 16 may be configured to, responsive to running the installed instance, determine whether the remote device 11 performed any actions included in a preset list of actions. In an example, the preset list of actions includes access to device information (phone number, International Mobile Equipment Identity (IMEI), subscriber ID, or the like), rooting attempts, file IO and/or network 10, access to contacts and/or media, Short Message Service (SMS) messages sent and/or received, phone calls, location requests, cryptographic Application Programming Interface (API) calls, network identifiers (URL's, IP addresses, or the like), or the like, or combinations thereof.

The processing devices 15 and 16 described herein interoperate to cause an application of a mobile device to be profiled. However, the principles described herein may be extended to profiling the application of other types of computing devices, for example, a desktop computer, a workstation, or the like.

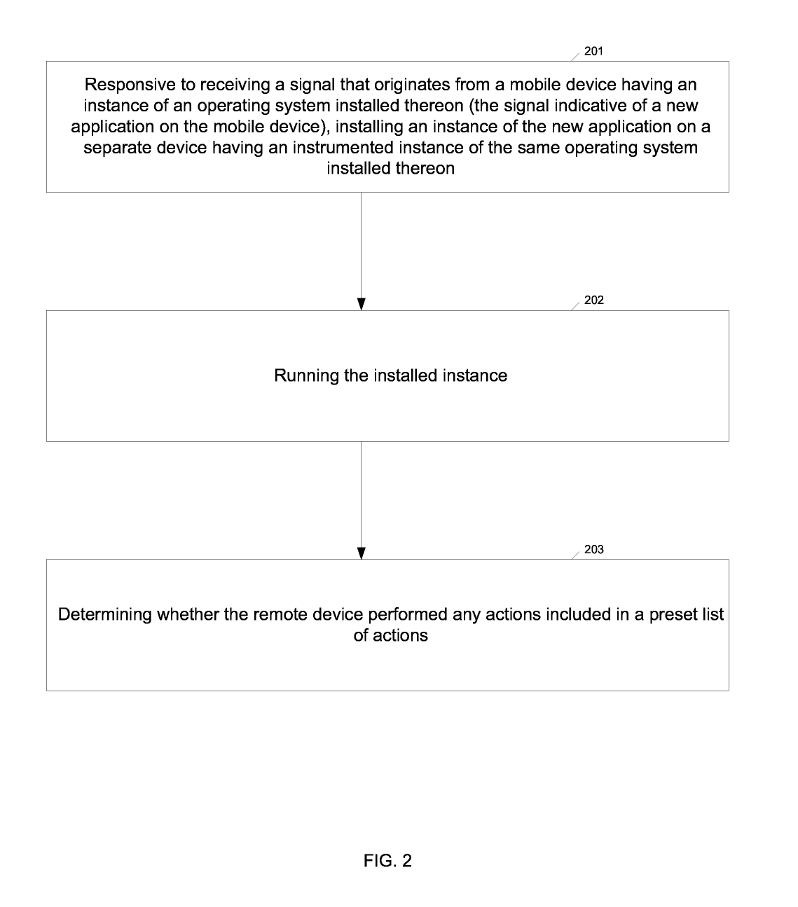

FIG. 2 illustrates a flow chart showing an application profiling operation of the processing device 16 of FIG. 1.

In block 201, responsive to receiving a signal that originates from a mobile device having an instance of an operating system installed thereon (the signal indicative of a new application on the mobile device), the processing device 16 installs an instance of the new application on a separate device having an instrumented instance of the same operating system installed thereon. The new application may be installed on the mobile device, or embargoed by the mobile device (downloaded by the mobile device but not yet installed and/or enabled). It should be appreciated that the processing device 16 may download the application from the mobile device, or any other location.

In an example, the processing device 16 modifies the downloaded application to generate an instrumented instance of the downloaded application prior to installation. The instrumented instance of the downloaded application may comprise the downloaded application with injected code configured to enable detection and/or actuation of user interface elements presented by the application. Generating the instrumented instance of the application may include decompiling the downloaded application, and recompiling the application with the code configured to enable detection and/or actuation of the user interface elements presented by the application. In such case, the installed instance of the application on the remote server may not be identical to an installed instance of the application on the mobile device.

In an example, responsive to receiving the signal, the processing device 16 checks a database having an entry for each application that has been previously profiled. If the new application (that is new for the mobile device) has already been previously profiled by the processing device 16 according to the database check, then the processing device 16 may not repeat profiling, i.e. may not install the instance of the new application responsive to receiving the signal. In an alternative example, the processing device 15 of the mobile device may have access to the database, in which case the signal may only be sent if the new application is not listed in the database.

In an example, the instrumented instance of the operating system includes a custom code layer configured to intercept a call, e.g., an application call, a system call, an intermediate layer call, or the like, and then relay the call to an appropriate layer, e.g., an application framework layer in the case of an application call, a kernel layer in the case of a system call, or an intermediate layer. The custom code layer may comprise a layer between the application and the application framework layer, a layer between the application framework layer and an intermediate layer, and a layer between the intermediate layer and the kernel layer. The processing device 16 may be configured to generate a record responsive to the custom code layer intercepting the call, as part of profiling the application.

In block 202, the processing device 16 runs the installed instance. In an example, processing device 16 detects a user interface element associated with one of the discovered entry points. Responsive to the detecting, processing device 16 simulates a user input to mimic a user interaction with the detected user interface element. For example, the processing device 16 may mimic a user interaction such as completing a form (filling in text forms, actuating soft buttons of the form, etc. in order to input user credentials, user selections, or the like). In an example, running the installed instances may include starting background processes to mimic normal application behavior.

In block 203, the processing device 16 determines whether the remote device performed any actions included in a preset list of actions. In an example, processing device 16 records a state of the remote device prior to installing the instance of the detected application on the remote device, and records a state of the remote device after running the installed instance. The processing device 16 compares the stored states to determine whether the remote device performed any actions included in the preset list of actions. In an example, a state comparison may be performed after a subset of actions performed by the remote device, e.g., after every action, so that a change detected according to the comparison may be correlated to a particular subset of the actions, e.g., to the most recent action.

In an example, the processing device 16 may align an operating system configuration of the remote device with the operating system configuration of the mobile device, prior to recording the initial state. For example, the operating system instance of the remote device may be set to enable or disable encryption according to whether encryption is enabled or disabled on the operating system of the mobile device. Other settings may be changed during alignment, e.g., a system application may be added or removed according to the operating system configuration of the mobile device, location services may be enabled or disabled according to the operating system configuration, a particular network setting may be enabled or disabled according to the operating system configuration of the mobile device, etc. The processing device 16 may perform the alignment responsive to receiving the signal, and the alignment may be based on information inserted into the signal by the processing device 15. In an alternative example, the processing device 16 may track the operating system configuration of the mobile device via communication with the processing device 15 in order to constantly maintain an aligned configuration on the remote device.

In an example, the processing device 16 may store in a memory device a result of the determination of whether the remote device performed any actions included in the preset list of actions. In an example, the processing device 16 may update the database of profiled applications responsive to determining whether the remote device performed any actions included in the preset list of actions. In an example, the processing device 16 may cause the embargo to be released and/or enable the installed application to be operated by the mobile phone responsive to determining whether the remote device performed any actions included in the preset list of actions. For example, the processing device 16 may release an embargo and/or enable the installed application to be operated by the mobile phone responsive to determining that the remote device did not perform any actions included in the preset list of actions.

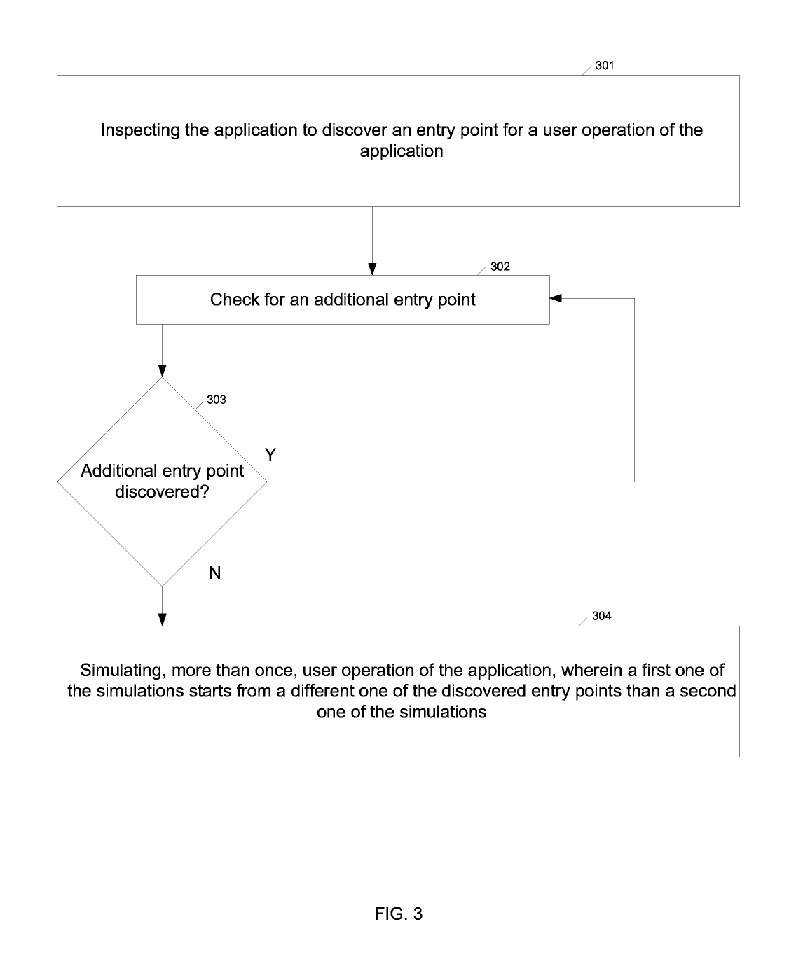

FIG. 3 illustrates a flow chart showing an entry point discovery operation of the processing device 16 of FIG. 1.

In block 301, processing device 16 inspects the application to discover an entry point for a user operation of the application. In block 302, processing device 16 checks for an additional entry point. As indicated by diamond 303, the process repeats until all entry points are discovered. In block 304, processing device 16 simulates, more than once, user operation of the application, wherein a first one of the simulations starts from a different one of the discovered entry points than a second one of the simulations.

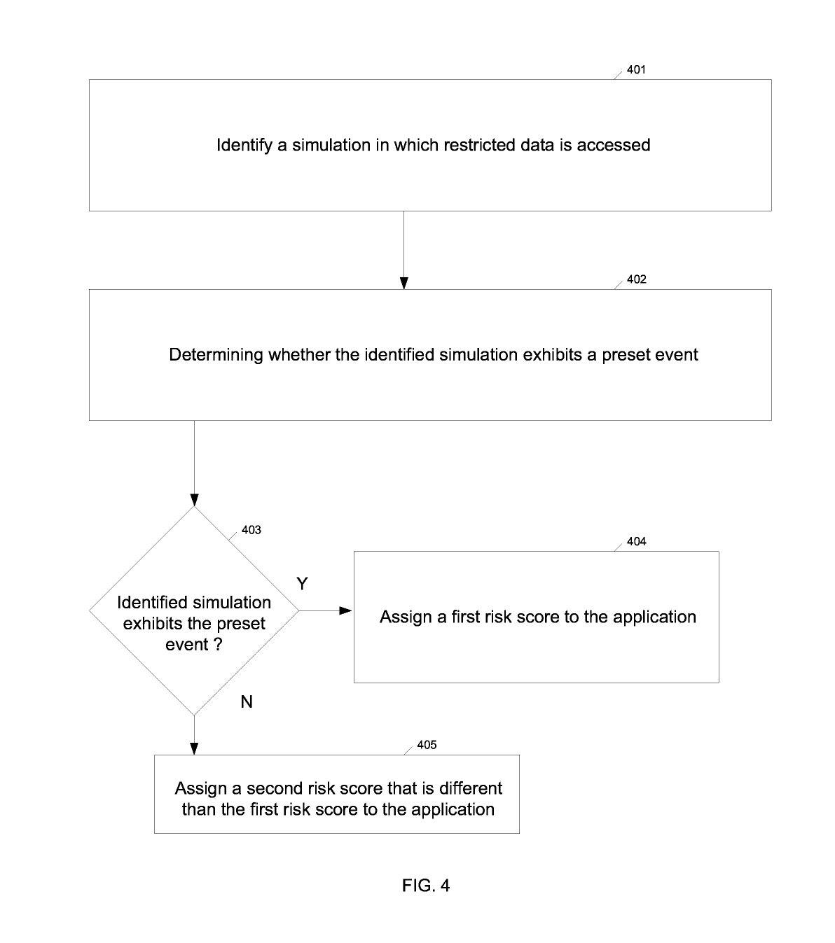

FIG. 4 illustrates a flow chart showing an event chaining operation of the processing device 16 of FIG. 1.

In block 401, processing device 16 identifies a simulation in which restricted data, e.g., personal data, is accessed. In block 402, processing device 16 determines whether the identified simulation exhibits a preset event. For example, the processing device 16 may determine whether the identified simulation exhibits an event associated with exporting the personal data. In an example, the preset event may include an action from the preset list of actions.

If the identified simulation exhibits the preset event in diamond 403, then in block 404 processing device 16 assigns a first risk score to the application. If the identified simulation does not exhibit the preset event, then in block 405 the processing device 16 assigns to the application a second risk score that is different than the first risk score. For example, the preset event may include an action from the preset list of actions, and the first risk score may reflect a greater risk than the second risk score.

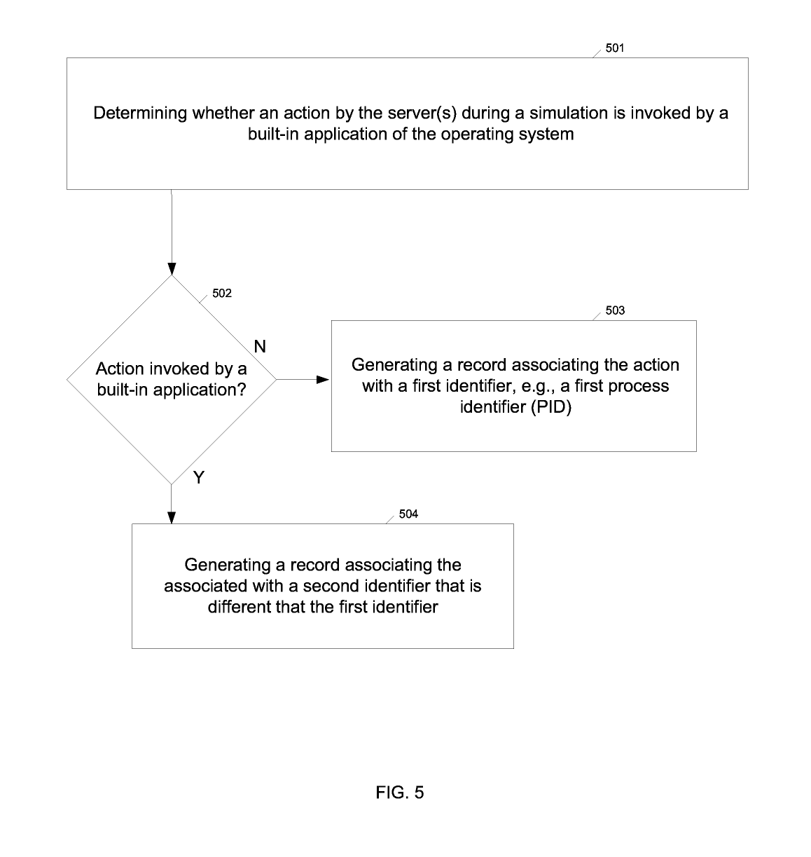

FIG. 5 illustrates a flow chart showing an application tracking operation of the processing device 16 of FIG. 1.

In block 501, processing device 16 determines whether an action by the server(s) during a simulation is invoked by a built-in application of the operating system. If the action is not invoked by a built-in application in diamond 502, then in block 503 processing device 16 generates a record associating the action with a first identifier, e.g., a first Process IDentifier (PID) assigned by the operating system. If the action is invoked by the built-in application in diamond 502, then in block 504 processing device 16 generates a record associating the action with a second identifier that is different than the first identifier, e.g., a second PID assigned by the operating system. In an example, the second identifier may correspond to the new application.

It will be obvious to those having skill in the art that many changes may be made to the details of the above-described embodiments without departing from the underlying principles of the invention. The scope of the present invention should, therefore, be determined only by the following claims.

Most of the equipment discussed above comprises hardware and associated software. For example, the typical electronic device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. A system, comprising:
a smartphone, tablet, or Personal Digital Assistant (PDA) having an instance of a mobile operating system installed thereon;
a remote device coupled to the smartphone, tablet, or PDA via a network, the remote device having an instrumented instance of the same mobile operating system installed thereon;
a memory device located on the remote device, the memory device having instructions stored thereon that, in response to execution by a processing device of the remote device, cause the processing device to perform operations comprising:
responsive to receiving a signal that originates from the smartphone, tablet, or PDA and is indicative of a new application on the smartphone, tablet, or PDA, installing an instance of the new application on the remote device;
running the installed instance; and
responsive to running the installed instance, determining whether the remote device performed any actions included in a preset list of actions.

2. The system of claim 1, wherein operations further comprise:
recording a state of the remote device prior to installing the instance of the detected application on the remote device;
recording a state of the remote device after running the installed instance; and
determining whether the remote device performed any actions included in the preset list of actions responsive to comparing the subsequently recorded state to the initially recorded state.

3. The system of claim 1, wherein the operations further comprise:
inspecting the application to discover an entry point for a user operation of the application;
further inspecting the application for an additional entry point;
repeating the further inspection until no further entry points are discovered; and
wherein running the installed instance further comprises simulating, more than once, user operation of the application, wherein a first one of the simulations starts from a different one of the discovered entry points than a second one of the simulations.

4. The system of claim 3, wherein the at least one of the simulations includes:
detecting a user interface element associated with one of the discovered entry points; and
responsive to the detecting, simulating a user input to mimic a user interaction with the detected user interface element.

5. The system of claim 3, wherein the operations further comprising determining, for each simulation, whether personal data is accessed during that simulation.

6. The system of claim 5, wherein the operations further comprise:
responsive to determining that personal data is accessed during one of the simulations, determining whether the one of the simulations exhibits an event associated with exporting the personal data;
assigning a first risk score to the application in response to determining that the one of the simulations exhibits the event associated with exporting the personal data; and
assigning a second risk score that is different than the first risk score in response to determining that the one of the simulations does not exhibit the event associated with exporting the personal data.

7. The system of claim 3, wherein the operations further comprise determining, for each simulation, whether restricted data is accessed during that simulation.

8. The system of claim 7, wherein the operations further comprise:
responsive to determining that restricted data is accessed during one of the simulations, determining whether the one of the simulations exhibits a preset event;
assigning a first risk score to the application in response to determining that the one of the simulations exhibits the present event; and
assigning a second risk score that is different than the first risk score in response to determining that the one of the simulations does not exhibit the preset event.

9. The system of claim 3, wherein the operations further comprise:
determining whether an action by the remote device during one of the simulations is invoked a built-in application of the mobile operating system;
responsive to determining that the action taken by the remote device during one of the simulations is not invoked by the built-in application of the mobile operating system, generating a record associating the action with a first process identifier (PID);
responsive to determining that the action taken by the remote device is invoked by the built-in application of the mobile operating system, generating a record associating the action with a second PID that is different than the first PID.

10. The system of claim 9, wherein the first PID corresponds to the new application.

11. The system of claim 1, wherein the operations further comprise downloading the new application responsive to receiving the signal.

12. The system of claim 1, wherein installing the instance of the new application on the remote device further comprises presenting by a server a smartphone platform, a tablet platform, or a PDA platform to the new application to cause the new application to respond during installation as if the server were a physical smartphone device, a physical tablet device, or a physical PDA device.

13. The system of claim 1, wherein the instrumented instance of the mobile operating system includes a custom code layer configured to intercept a call and then relay the call to an appropriate layer.

14. The system of claim 13, wherein the operations further comprise generating a record responsive to the custom code layer intercepting the call.

15. An apparatus, comprising:
a memory device having instructions stored thereon that, in response to execution by a processing device, cause the processing device to perform operations comprising:
responsive to receiving a signal that originates from a mobile device having an instance of an operating system installed thereon, the signal indicative of a new application on the mobile device, installing an instance of the new application on a separate device having an instrumented instance of the same operating system installed thereon;
running the installed instance; and
responsive to running the installed instance, determining whether the separate device performed any actions included in a preset list of actions.

16. The apparatus of claim 15, wherein operations further comprise:
recording a state of the separate device prior to installing the instance of the detected application on the separate device;
recording a state of the separate device after running the installed instance; and
determining whether the separate performed any action included in the preset list of actions responsive to comparing the subsequently recorded state to the initially recorded state.

17. The apparatus of claim 15, wherein the operations further comprise:
inspecting the application to discover an entry point for a user operation of the application;
further inspecting the application for an additional entry point;
repeating the further inspection until no further entry points are discovered; and
wherein running the installed instance further comprises simulating, more than once, user operation of the application, wherein a first one of the simulations starts from a different one of the discovered entry points than a second one of the simulations.

18. A method, comprising:
responsive to receiving a signal that originates from a mobile device having an instance of a operating system installed thereon, the signal indicative of a new application on the mobile device, installing an instance of the new application on a separate device having an instrumented instance of the same operating system installed thereon;
running the installed instance; and
responsive to running the installed instance, determining whether the separate device performed any actions included in a preset list of actions.

19. The method of claim 18, further comprising:
recording a state of the separate device prior to installing the instance of the detected application on the separate device;
recording a state of the separate device after running the installed instance; and
determining whether the separate device performed any actions included in the preset list of actions responsive to comparing the subsequently recorded state to the initially recorded state.

20. The method of claim 18, further comprising:
inspecting the application to discover an entry point for a user operation of the application;
further inspecting the application for an additional entry point;
repeating the further inspection until no further entry points are discovered; and
wherein running the installed instance further comprises simulating, more than once, user operation of the application, wherein a first one of the simulations starts from a different one of the discovered entry points than a second one of the simulations.
